(19) United States
(12) Patent Application Publication
(10) Pub. No.: US 2016/0199996 A1
(43) Pub. Date: Jul. 14, 2016

(54) HANDLING DEVICE

(71) Applicant: WEBER MASCHINENBAU GMBH BREIDENBACH, Breidenbach (DE)

(72) Inventor: Gunther Weber, Gross Nemerow (DE)

(21) Appl. No.: 14/914,481

(22) PCT Filed: Aug. 8, 2014
(86) PCT No.: PCT/EP2014/067082

§ 371 Date: Feb. 25, 2016

(30) Foreign Application Priority Data
Aug. 28, 2013 (DE) 10 2013 217 139.0

(51) Int. Cl. B26D 7/26; B26D 1/14; B26D 7/12; B26D 1/25

(52) U.S. Cl. CPC B26D 7/2614; B26D 1/25; B26D 1/14; B26D 7/12

(57) ABSTRACT

The invention relates to a handling device for handling a rotary cutter comprising at least two segments, said cutter being in particular a curved or circular blade, in particular for the transport of said blade to and the mounting and/or dismantling thereof on or from a blade receiving element which is preferably on a device for sharpening rotary cutters or a device for slicing food products. Said handling device comprises at least two receiving parts, each receiving part being designed to receive one segment.

The invention relates to a handling apparatus for handling a rotary blade, in particular a scythe-like blade or circular blade, in particular for transport to or installation or dismantling at a blade mount. The blade mount is preferably provided at an apparatus for grinding or sharpening rotary blades or at an apparatus for slicing food products, for example sausage, ham, cheese or the like. The slicing apparatus can in particular be a high-performance slicer.

The invention also relates to a method for installing or dismantling a rotary blade using a handling apparatus.

Handling apparatus, which are also called blade guards, are generally known, To install a blade on a blade mount or to dismantle the blade, the blade can be held by a handling apparatus formed as a carrier. The handling apparatus can be provided with a blade guard. Handles can also be provided. The blade can in this manner be securely held and stored by an operator.

Conventional rotary blades are, however, typically heavy and comparatively large. The carrying of a blade received in the handling apparatus and the holding of the blade using the handling apparatus on the attachment into and removal of the blade in or at a machine is thus difficult since it is always the whole blade which has to be held.

The handling is in particular disadvantageous in this manner.

It is an object of the invention to improve a handling apparatus with respect to its ease of handling, in particular on the transport, installation and/or dismantling of a rotary blade.

This object is satisfied by an apparatus having the features of claim 1 and by methods having the features of claim 11 or 12.

In accordance with the invention, the handling apparatus is configured for the attachment of a rotary blade comprising at least two segments. The rotary blade can in this respect generally have as many segments as required, for example two, three, four, five or more segments. Accordingly, it is in particular not a single-piece rotary blade.

In particular that part region of the rotary blade of any desired shape can be considered as a segment which is separate from the remaining blade, with all the segments together forming the rotary blade with respect to shape and function. The segments of a blade can in particular have the same shape and can, for example, be of the same construction.

The rotary blade can in particular be a scythe-like blade having exactly one spiral. The spiral can, for example also be called a scythe or a leaf. A conventional scythe-like blade having a single spiral can thus e.g. be divided into two segments.

Furthermore, scythe-like blades are in particular also possible having a plurality of spirals, for example two, three, four, five or more spirals. Scythe-like blades having a plurality of spirals are also called multi-leaf scythe-like blades or multi-spiral blades.

Each segment can preferably have exactly one spiral.

A blade edge can in particular extend along one or each spiral.

it is also possible that a circular blade which by definition has no spiral is divided into a plurality of segments. With a circular blade having two segments, each segment can thus in particular be formed in the shape of a semicircle.

In accordance with the invention, the handling apparatus has at least two, three, four five or more reception parts, with each reception part being configured for receiving a segment, in particular exactly one segment.

The number of the reception parts preferably corresponds to the number of segments.

The individual segments can be transported independently of one another in this manner. The weight to be transported is thereby substantially reduced since the blade does not have to be moved as a whole. The Installation or dismantling of the individual segments at the blade mount by means of the respective reception parts can also take place independently of one another. Only one segment thus also preferably has to be held on the installation or dismantling.

The handling is considerably improved in accordance with the invention since it is not the whole blade which has to be dismantled or transported at once.

On the grinding of known single-piece scythe-like blades, there is, for example, the disadvantage that the whole peripheral region cannot be ground. A so-called run-out region, which cannot be reached by a grinding device, is thus e.g. provided in the vicinity of an edge of the spiral which does not serve as a blade edge region.

Such a run-out region can be omitted on a separate machining of the segments since the segments can be ground independently of one another. Blade edge regions of 360° are thus possible. The blade edge region can also be larger than 360° depending on the geometry of the segments.

The segments can in this respect in particular be ground spatially separately from one another. The segments received in a grinding apparatus can thus be spaced apart from one another, for example.

If a blade edge region of approximately 270° is exceeded, it in particular results from the geometry of the blade that it can only be ground when the center spacing in the grinding unit is increased. The grinding wheels would otherwise not fit between the segments.

Since the handling apparatus is divided into reception parts, the individual segments can be placed onto a grinding apparatus separately from one another, consecutively or simultaneously, e.g. at any desired positions, in particular at mutually spaced apart blade mounts. The individual segments can in particular also be removed from one another again independently.

The handling apparatus in accordance with the invention can thus be used variably.

The term “grinding” is, on the one hand, to be understood as a first formation of a blade edge and, on the other hand, also as a sharpening of segments which have become blunt, for example.

The blade edges of the individual segments can preferably be received in the reception parts. In this case, the reception parts can thus in particular serve as blade guards.

Further developments of the invention can also be seen from the dependent claims, the description and the enclosed drawings.

In accordance with an embodiment, each reception part is adapted to the contour and/or to the size of the respective segment.

The reception parts can in particular each be shaped such that they receive the respective segments at least substantially with an exact fit.

With a circular blade, the reception parts can thus, for example, be shaped as circular segments. With a scythe-like blade, at least one reception part can have a scythe-like structure.

The reception parts are preferably dimensioned larger than the respective segments to be able to receive the segments as a whole and to provide transport protection.

The individual reception parts can in particular be identical, in particular of the same size. This is conceivable, for example, with circular blades or with scythe-like blades having a plurality of spirals which are divided into segments of the same construction.

If a scythe-like blade having only one spiral is divided into a plurality of segments, the reception parts can thus in particular have different contours and/or sizes.

In accordance with a further embodiment, the reception parts are different, in particular mirror inverted.

The base body of the respective reception parts can in particular be different, whereas the handles can e.g. be of any desired orientation, i.e. thus also the same.

The reception parts can thus differ from one another, in particular in dependence on the contour and/or size of the respective segments. This is in particular possible with a scythe-like blade having only one spiral and divided into a plurality of segments.

With circular blades or scythe-like blades having a plurality of spirals, the reception pats can, however, for example, also be of the same construction.

The reception parts can in particular be of different sizes. One reception part is preferably larger than at least one other reception part. This is in particular the case when a scythe-like blade having only one spiral is divided into two segments. The reception parts can in this respect in particular be formed as semicircles having radii which differ from one another, wherein the radii can in particular constantly change in the peripheral direction.

In accordance with a further embodiment, the reception parts are formed in one piece. The reception parts can in particular be connected to one another rigidly and/or non-releasably. The handling apparatus can thus preferably be formed in one piece, wherein each reception part is formed as a reception region for receiving a segment.

In accordance with an alternative embodiment, the reception parts can be separate components. The handling apparatus is thus preferably not formed in one piece. The reception parts can in this respect be considered as part pieces.

The reception parts can be releasably connectable to one another, in particular by means of a screwing apparatus, latching apparatus, sliding apparatus and/or clamping apparatus. Any desired connection apparatus are generally possible. An unambiguous association can thereby also be achieved with separate reception parts.

The reception parts can thus be screwed to one another, for example. A bayonet fastening is e.g. also possible. A magnetic connection of the reception parts can furthermore be provided.

The reception parts can preferably be connected to one another and/or separated again without tools.

The reception parts can in particular be connected to one another for storage. An unambiguous association of the segments received in the reception parts is thereby ensured. The segments can in this manner preferably be reused in pairs.

If the segments are not spaced apart from one another and are, for example, arranged on a common blade mount, the segments can be received together in a handling apparatus in which the reception parts are connected to one another. The segments can in particular thus be removed from and/or placed on the blade mount of a slicing apparatus together.

The installation or dismantling can in particular take place together or individually due to the releasable connection.

In accordance with a further embodiment, the reception pats can be or are connected to one another in a position in which they are arranged, in particular in alignment, adjacently in a plane.

The individual reception parts are preferably arranged next to one another. The reception parts can in particular be directly adjacent at a region remote from a reception region of the blade edge. These regions can in particular adjoin one another in an aligned manner. The reception parts can preferably be adjacent to one another at a straight line.

In an alternative embodiment, the reception parts can be or are connected to one another in a position in which they are arranged in an at least partly overlapping manner.

The individual reception parts are in this respect in particular located above one another in different planes.

The reception parts can preferably be arranged in a completely overlapping manner.

An overlapping arrangement in particular makes a space-saving storage possible.

In accordance with a further embodiment, the connected reception parts are stored with respect to one another in a movable, in particular displaceable, manner.

The connection is thus in particular not rigid. In this manner, segments which are at least slightly offset from one another, for example when the blade mounts have a slight offset, can also be received in the connected state of the reception parts.

In accordance with a further embodiment, each reception part comprises at least one handle, wherein preferably exactly two handles are provided per reception part. With an overlapping arrangement, the handles of the lower part piece can in particular be configured fully or partly for fixing the upper part piece.

Each reception part can thus be moved separately. The handling is considerably facilitated by the handles. In addition, a risk of injury is minimized since the handles are arranged remote from the blade edges received in the reception parts. In accordance with a further embodiment, exactly two reception parts are provided, wherein in particular every reception part has a semicircular contour, preferably having a mutually different radius.

The contour is in this respect in particular determined with reference to the contour of the individual segments. A scythe-like blade having a single spiral can thus e.g. have two segments which each have a semicircular contour having a mutually different radius. A circular blade divided into segments can, in contrast, have a semicircular contour having respective identical radii, for example.

The handling apparatus or the individual reception parts of the handling apparatus can in particular satisfy at least one further function in addition to the holding of the blade or of the segment.

This additional function can, for example, comprise the releasing of a security against rotation, in particular of at least one securing pin, which secures the blade or at least a segment at the blade mount.

The additional function can also comprise an adjustment of a clamping device of the blade mount between a clamping state clamping the blade or the segment and a release state. The handling apparatus or at least a reception part can in this respect serve as an actuation device, for example.

The additional function can also comprise a storage of energy, in particular of current or of a pressurized fluid or spring energy, wherein the handling apparatus or at least a reception part in particular comprises a rechargeable energy store. The handling apparatus or at least a reception part can thus, for example, include a pressure tank filled with compressed air.

The additional function can furthermore comprise the output of energy, in particular of stored energy, into the blade mount. Compressed air, for example, which can be stored in the handling apparatus or in at least one reception part, can thus be output to the blade mount for actuating the actuation device.

The invention additionally relates to a method of installing a rotary blade, in particular a scythe-like blade or circular blade, comprising at least two segments at a blade mount, in particular at an apparatus for grinding or sharpening rotary blades or at an apparatus for slicing food products, for example sausage, cheese, ham or the like. The slicing apparatus can in particular be a high-performance slicer.

The installation takes place using a handling apparatus in accordance with the invention, wherein the segments are first received in or by the respective reception parts. The reception parts are separate from one another or are connected to one another, in particular releasably or in one piece.

The segments are subsequently placed onto the blade mount with the aid of the reception parts and are fixed to the blade mount.

The segments can be screwed to the respective reception parts, for example, for the reception. Any desired fastening apparatus are generally possible, for example screwing apparatus, latching apparatus, sliding apparatus and/or clamping apparatus.

The segments can preferably be releasably connected to the reception parts.

In accordance with an embodiment, the placement of the segments takes place individually.

The segments can in particular be placed onto the blade mount spatially separate from one another. The segments can also be placed on consecutively, in particular in time.

Depending on the configuration of the blade mount, the segments can also be placed on together with the aid of mutually connected reception parts.

If the segments are placed on individually, the handling is considerably improved. Only the weight of a segment thus also always has to be moved and/or held and not the weight of the total blade.

The invention additionally relates to a method of dismantling a rotary blade, in particular a scythe-like blade or circular blade, comprising at least two segments from a blade mount, in particular from an apparatus for grinding or sharpening rotary blades or from an apparatus for slicing food products, for example sausage, ham, cheese or the like. The slicing apparatus can in particular be a high-performance slicer.

The dismantling takes place with the aid of a handling apparatus in accordance with the invention, wherein the segments fixed to the blade mount are received in or by the respective reception parts.

The segments can in particular be connected to the reception parts, for example by means of a screwing apparatus, a latching apparatus, a sliding apparatus and/or a clamping apparatus. The segments are preferably screwed to the reception parts.

The reception parts can be separate from one another or can be connected to one another, in particular releasably or in one piece. This in particular depends on the design of the blade mount. If the segments are e.g. not fixed on a blade mount spaced apart from one another, the reception parts can be connected to one another for receiving the segments. If the segments are, however, fixed to a grinding apparatus, for example, to different blade mounts spaced apart from one another, the reception parts can thus be separate from one another to be able to receive the individual segments spaced apart from one another.

The segments are released from the blade mount. The segments are subsequently removed from the blade mount with the aid of the reception parts.

In accordance with an embodiment, the removal of the segments take place individually. This is in particular the case when the segments are spaced apart from one another at different blade mounts. The removal preferably takes place independently of one another, e.g. spatially separate. The removal can also take place consecutively in time.

It is, for example, possible that the individual segments are removed from the blade mounts by different operators, in particular also simultaneously.

In accordance with a further embodiment, the reception parts are connected to one another, in particular releasably, for the storage of the segments. The reception parts can in this respect be connected next to one another or above one another. The association of the individual segments with one another can be ensured in this manner.

All the embodiments of the apparatus described here are in particular configured to be operated in accordance with one or more of the methods described here. Furthermore, all the embodiments of the apparatus described here as well as all the embodiments of the methods described here can each be combined with one another.

The invention will be described in the following by way of example with reference to the drawings. There are shown:

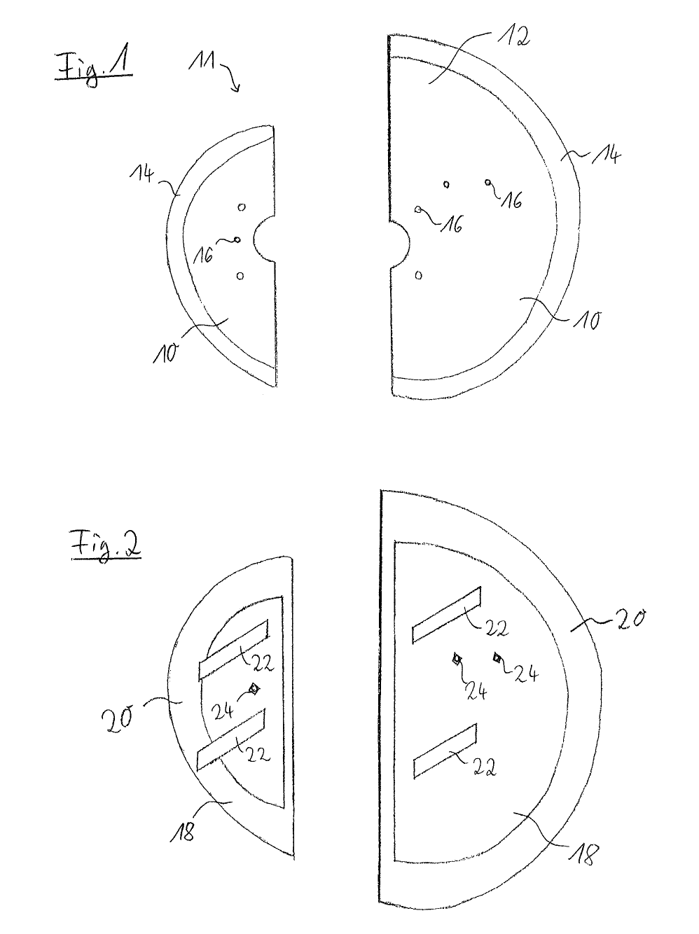

FIG. 1 a front view of a scythe-like blade comprising two segments;

FIG. 2 a front view of a first embodiment of a handling apparatus in accordance with the invention;

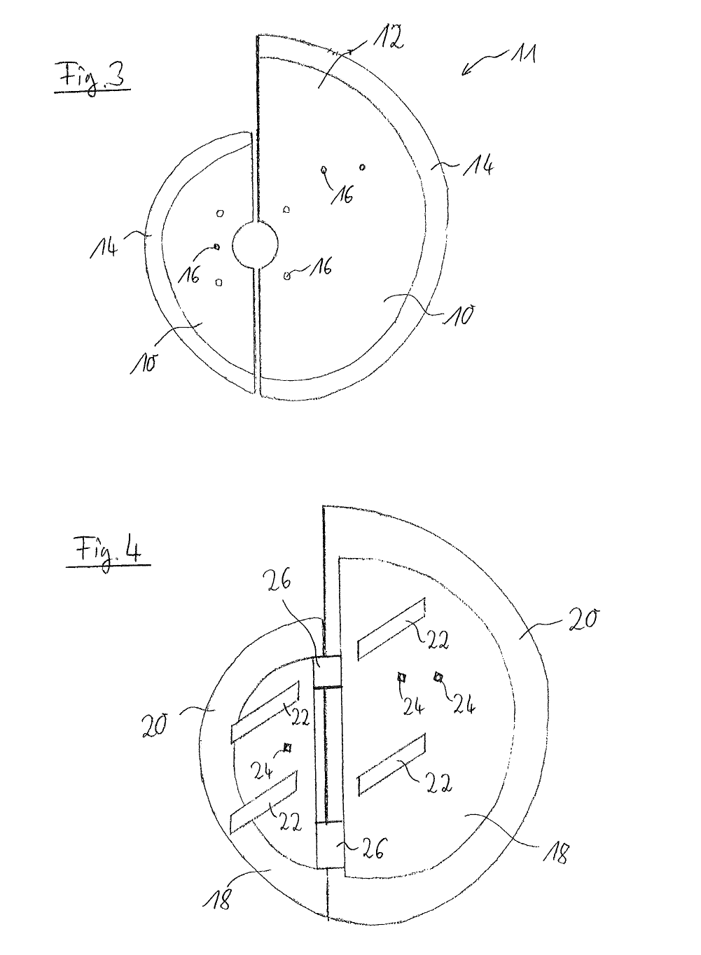

FIG. 3 a front view of the scythe-like blade in accordance with FIG. 1, with the segments not having any spacing;

FIG. 4 a front view of the handling apparatus in accordance with FIG. 2 with reception parts connected next to one another;

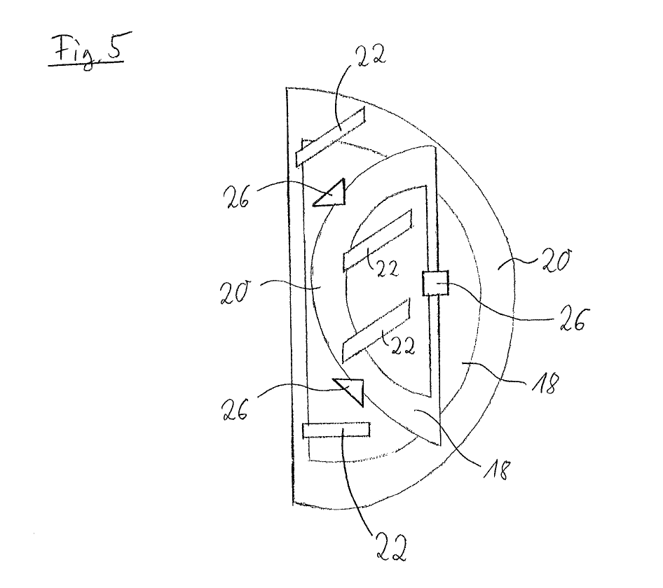

FIG. 5 a front view of the handling apparatus in accordance with FIG. 2 with reception parts connected above one another;

FIG. 6 a front view of a circular blade comprising two segments;

FIG. 7 a front view of a second embodiment of a handling apparatus in accordance with the invention;

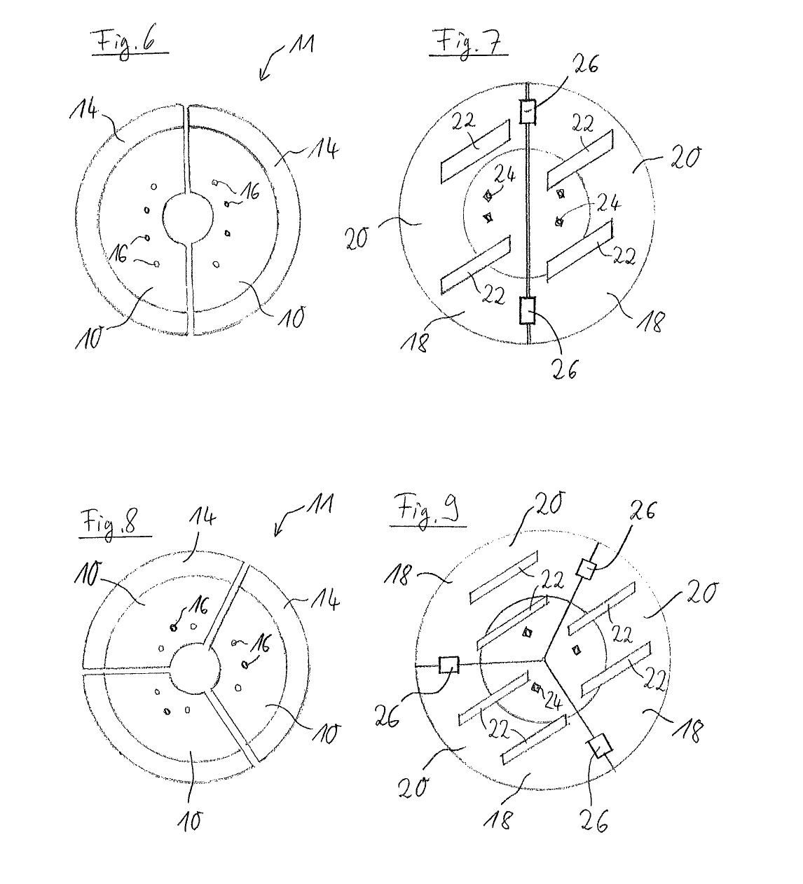

FIG. 8 a front view of a circular blade comprising three segments; and

FIG. 9 a front view of a third embodiment of a handling apparatus in accordance with the invention.

FIG. 1 shows a blade 11 formed as a scythe-like blade having two segments 10, wherein a segment 10 has one spiral 12. Each segment 10 comprises a blade edge 14 as well as a plurality of cut-outs 16.

The segments 10 are spaced apart from one another and can, for example, be installed on mutually separate blade mounts, for example on an apparatus for grinding and/or sharpening.

Since the segments 10 are installed separately from one another, cutting regions of up to 360° and larger can e.g. be ground.

A handling apparatus having two reception parts 18 is shown in FIG. 2. The reception parts 18 are configured for receiving a blade 11 in accordance with FIG. 1.

The contour of the individual reception parts 18 is respectively adapted to the contour of the individual segments 10 of the blade 11. The reception parts 18 in this respect have different radii.

Each reception part comprises a blade edge receiver 20 in which the blade edges 14 of the segments 10 can be received. Each reception part 18 furthermore comprises two handles 22 as well as screws 24.

The reception parts 18 can be placed individually onto the segments 10 for dismantling a blade 11. The segments 10 can be fastened to the respective reception parts 18 with the aid of screws 24 which can engage into cut-outs 16 of the segments 10. The segments 10 are subsequently released from the blade mount and can thus be removed and transported with the aid of the reception parts 18 at the handles 22.

The blade 11 in accordance with FIG. 1 is installed at a mount in which the segments are not spaced apart from one another in FIG. 3. In this configuration, the segments 10 can, for example, be installed at a blade mount of a slicing apparatus.

In FIG. 4, the reception parts 18 of the handling apparatus in accordance with FIG. 2 are connected to one another by means of a connection apparatus configured as a latching apparatus 26. The individual reception parts 18 can be releasably connected to one another with the aid of the latching apparatus 26.

In this configuration, the blade 11 in accordance with FIG. 3 can be removed from a blade mount or installed on a blade mount as a whole, for example.

It is also possible first to receive segments 10 spaced apart from one another, as are shown in FIG. 1, individually in the reception parts 18 and subsequently to connect the reception parts 18 to one another by means of the latching apparatus 26. The segments 10 can, for example, be transported and/or stored in this connected configuration.

In FIG. 5, the reception parts 18 are, unlike the embodiment in accordance with FIG. 4, not in a common plane, but lie above one another. The segments 10 can also be stored in this position. An unambiguous association of the segments 10 is ensured due to the common storage.

The connection apparatus 26 can, for example, comprise a sliding mechanism in which a reception part 18 is pushed onto the other reception part 18 and is secured.

A blade 11 configured as a circular blade having two segments 10 is shown in FIG. 6. The segments 10 can be received in the reception parts 18 of a handling apparatus shown in FIG. 7. These reception parts 18 can also be connected to one another by means of a connection apparatus 26.

A circular blade 11 having three segments 10 is shown in FIG. 8. The individual segments 10 can be received in the reception parts 18 of a handling apparatus shown in FIG. 9. Each of the reception parts 18 is formed as a circular segment in this respect.

The individual reception parts 18 can be connected to one another by means of a connection device 26.

The handling of rotary blades can be considerably increased by the handling apparatus in accordance with the invention since, for example, individual segments of a rotary blade can be moved independently of one another.

### REFERENCE NUMERAL LIST

10 segment
11 blade
12 spiral
14 blade edge
16 cut-out
18 reception part
20 blade edge receiver
22 handle
24 screws
26 latching apparatus, connection apparatus

1-14. (canceled)

15. A handling apparatus for handling a rotary blade having at least two segments, the handling apparatus comprising at least two reception parts, wherein each reception part is configured for receiving one of the at least two segments.

16. The handling apparatus in accordance with claim 15, wherein the rotary blade is a scythe-like blade or a circular blade.

17. The handling apparatus in accordance with claim 15, wherein the handling apparatus is used for the transport, installation and/or dismantling at a blade mount.

18. The handling apparatus in accordance with claim 15, wherein the handling apparatus is used for handling the rotary blade at an apparatus for grinding rotary blades or at an apparatus for slicing food products.

19. The handling apparatus in accordance with claim 15, wherein each of the at least two reception parts is adapted to the contour and/or size of the respective received segment.

20. The handling apparatus in accordance with claim 15, wherein the at least two reception parts are formed differently.

21. The handling apparatus in accordance with claim 20, wherein the differently formed reception parts are of different size.

22. The handling apparatus in accordance with claim 15, wherein the at least two reception parts are formed in one piece.

23. The handling apparatus in accordance with claim 15, wherein the at least two reception parts can be releasably connected to one another.

24. The handling apparatus in accordance with claim 23, wherein the at least two reception parts are connectable to one another in a position in which they are arranged adjacently in a plane.

25. The handling apparatus in accordance with claim 24, wherein the at least two reception parts are connectable to one another in a position in which they are arranged in an aligned manner adjacently in the plane.

26. The handling apparatus in accordance with claim 23, wherein the at least two reception parts are connectable to one another in a position in which they are arranged overlapping at least in part.

27. The handling apparatus in accordance with claim 23, wherein the connected at least two reception parts are stored movably with respect to one another.

28. The handling apparatus in accordance with claim 27, wherein the connected reception parts are stored displaceably with respect to one another.

29. The handling apparatus in accordance with claim 15, wherein each of the at least two reception part comprises at least one handle (22).

30. The handling apparatus in accordance with claim 15, wherein exactly two reception parts are provided.

31. The handling apparatus in accordance with claim 30, wherein each of the at least two reception part has a semicircular contour.

32. The handling apparatus in accordance with claim 31, wherein each of the at least two reception part has a mutually different radius.

33. A method of installing a rotary blade comprising at least two segments to a blade mount with a handling apparatus, the handling apparatus having at least two reception parts, wherein each reception part is configured for receiving one of the at least two segments, the method comprising the steps of:
receiving the segments in and/or by the respective one of the at least two reception parts, wherein the at least two reception parts are separate from one another or are connected to one another;
placing the segments onto the blade mount with the aid of the at least two reception parts; and
fixing the segments to the blade mount.

34. The method in accordance with claim 33, wherein the placing on and/or removing of the segments takes place individually.

35. The method in accordance with claim 34, wherein the at least two reception parts are connected to one another for storing the segments.

36. A method of dismantling a rotary blade comprising at least two segments from a blade mount with a handling apparatus, the handling apparatus having at least two reception parts, wherein each reception part is configured for receiving one of the at least two segments, the method comprising the steps of:
receiving the segments fixed to the blade mount in the respective one of the at least two reception parts, wherein the at least two reception parts are spaced apart from one another or are connected to one another;
releasing the segments from the blade mount; and
removing the segments from the blade mount with the aid of the at least two reception parts.

37. The method in accordance with claim 36, wherein the placing on and/or removing of the segments takes place individually.

38. The method in accordance with claim 37, wherein the at least two reception parts are connected to one another for storing the segments.
